(19) United States
(12) Patent Application Publication
(10) Pub. No.: US 2021/0275845 A1
(43) Pub. Date: Sep. 9, 2021

(54) FIRE SUPPRESSION SYSTEM FOR AVIATION VEHICLE

(71) Applicant: CONSTRUCTION HELICOPTERS, INC., Howell, MI (US)

(72) Inventors: Christopher G. TURNER, Howell, MI (US); Chirag DUDHAT, Howell, MI (US); Eric S. FOY, Howell, MI (US)

(21) Appl. No.: 17/189,929

(22) Filed: Mar. 2, 2021

Related U.S. Application Data
(60) Provisional application No. 62/984,489, filed on Mar. 3, 2020.

(51) Int. Cl. A62C 3/02; A62C 31/02; A62C 37/10; B64D 1/18

(52) U.S. Cl. CPC A62C 3/0242; A62C 31/02; B64D 1/22; B64D 1/18; A62C 37/10

(57) ABSTRACT

A fire-suppression system includes an aviation vehicle and a fluid transport and delivery system. The fluid transport and delivery system is coupled to a vehicle frame of the aviation vehicle and is located within a cabin of the vehicle frame. The fluid transport and delivery system includes a tank having an exit aperture formed in a bottom wall of the tank, a plug aligned with the exit aperture of the tank, and a plug actuator configured to move the plug along an axis from an open position, in which the fluid stored in the tank passes around the plug and through the exit aperture, to a closed position, in which fluid is blocked from exiting through the exit aperture.

### PRIORITY CLAIM

This application claims priority under 35 U.S.C. § 119(e) to U.S. Provisional Application No. 62/984,489, filed Mar. 3, 2020, which is expressly incorporated by reference herein.

### BACKGROUND

The present disclosure relates to a system for extinguishing fires and in particular to a system for extinguishing fires including an aerial vehicle. More particularly, the present disclosure relates to a system for extinguishing fires including an aerial vehicle and a tank coupled to the aerial vehicle for storing fluid used to extinguish the fire.

### SUMMARY

The present disclosure may comprise one or more of the following features and combinations thereof.

A system in accordance with the present disclosure includes a vehicle and a tank coupled to the vehicle for transporting fluid within the tank to a fire so that the fire can be extinguished using the system. In illustrative embodiments, the system is a fire-suppression system that includes a helicopter and a fluid transport and delivery system coupled to the helicopter. The helicopter includes a frame and a propulsion system coupled to the frame to provide lift and thrust for the helicopter for aerial flight. The frame is formed to include a cabin that houses various components of the helicopter including the fluid transport and delivery system.

In illustrative embodiments, the fluid transport and delivery system includes a tank that is formed to include an internal fluid-storage region. Both the tank and the vehicle frame of the helicopter are formed to include exit apertures that may be opened upon arrival at a fire to release fluid from the internal fluid-storage region and onto the fire below the helicopter. The vehicle frame may include a door that is opened separately from the exit aperture of the tank.

In illustrative embodiments, the fluid transport and delivery system further includes a plug arranged in the internal fluid-storage region of the tank and a plug actuator coupled to the plug. The plug is movable along a vertical axis from a closed position where the plug blocks fluid flow out of the exit aperture of the tank and an opened position where the plug is moved away from the exit aperture by the plug aperture to release the fluid.

In illustrative embodiments, the plug has an inverted tear-drop shape when viewed in cross-section and cooperates with an exit nozzle included in the tank to produce a laminar flow of fluid released from the tank for precision aerial firefighting. The plug has an outer surface with a contour that releases the fluid from the exit aperture and maintains cohesion of the fluid as the fluid drops below a slipstream produced by the propulsion system of the helicopter thereby increasing an amount of fluid that reaches the fire below the helicopter.

These and other features of the present disclosure will become more apparent from the following description of the illustrative embodiments.

### BRIEF DESCRIPTION OF THE DRAWINGS

FIG. 1 is a perspective view of a fire suppression system that includes a helicopter with portions cut away to show that the fire suppression system further includes a fluid transport and delivery system housed in a cabin of the helicopter and having a tank arranged to lie in the cabin of the helicopter and an exit nozzle overlying a discharge aperture formed in a bottom of the helicopter so that the fluid transport and delivery system discharges fluid through the exit aperture and onto a fire when the helicopter is positioned above the fire;

FIG. 2 is a diagrammatic and cross-sectional view of the fluid transport and delivery system of FIG. 1 showing the system includes a tank, a plug having an inverted teardrop shape and coupled to the base of the plug actuator, and a plug actuator that controls the height of the plug relative to the exit nozzle in the tank, and showing that the tank further includes a plurality of interior baffles to minimize motion of the fluid within the tank during flight maneuvers and a tank support unit that mounts the tank within the cabin of the helicopter;

FIG. 3 is an exploded assembly view of the fluid transport and delivery system of FIG. 1 showing that the plug actuator and the plug are aligned with the exit nozzle of the tank along a vertical axis;

FIG. 4 is a diagrammatic and cross-sectional view of the fluid transport and delivery system of FIG. 1 showing the plug in an open position to allow fluid to exit the tank between the outer surface of the plug and the inner surface of the exit nozzle such that the shape of the outer surface and the inner surface cooperate to provide a laminar flow as the fluid exits the tank;

FIG. 5 is a diagrammatic and cross-sectional view of the fluid transport and delivery system of FIG. 1 showing the plug in a closed position so that the outer surface of the plug engages with the inner surface of the exit nozzle to block fluid from exiting the tank;

FIG. 6 is a cross-sectional view of the plug of FIG. 2 showing that the inverted teardrop shape of the plug is defined by an upper convex portion above the maximum diameter of the plug, a lower portion below the maximum diameter of the plug that has both convex and concave regions, and a point end component that is shaped to have a narrow point at the lowest position of the plug;

FIG. 7 is an exploded assembly view of the plug of FIG. 2 showing that the plug has a substantially circular cross-section when viewed along the vertical axis;

FIG. 8 is a perspective view of another embodiment of a fire suppression system showing a fluid transport and delivery system located inside the frame rails of a helicopter and the fluid transport and delivery system includes a tank that is mounted to the frame with a forward and aft support structure containing struts and stringers;

FIG. 9 is a diagrammatic and cross-sectional view of the fluid transport and delivery system of FIG. 8 showing the system includes a tank, a plug having an inverted teardrop shape and coupled to the base of the plug actuator, and a plug actuator that controls the height of the plug relative to the exit nozzle in the tank, and showing that the tank further includes a plurality of interior baffles to minimize motion of the fluid within the tank during flight maneuvers and a tank support unit that mounts the tank within the cabin of the helicopter; and

FIG. 10 is a picture of an exterior view of the fluid transport and delivery system of FIG. 8 showing the system includes a tank comprising of a shell made from composite material and a support structure at the front and rear of the tank, the support structures include struts and stringers that mount to the tank at mounting flanges on the exterior of the shell.

### DETAILED DESCRIPTION

For the purposes of promoting an understanding of the principles of the disclosure, reference will now be made to a number of illustrative embodiments illustrated in the drawings and specific language will be used to describe the same.

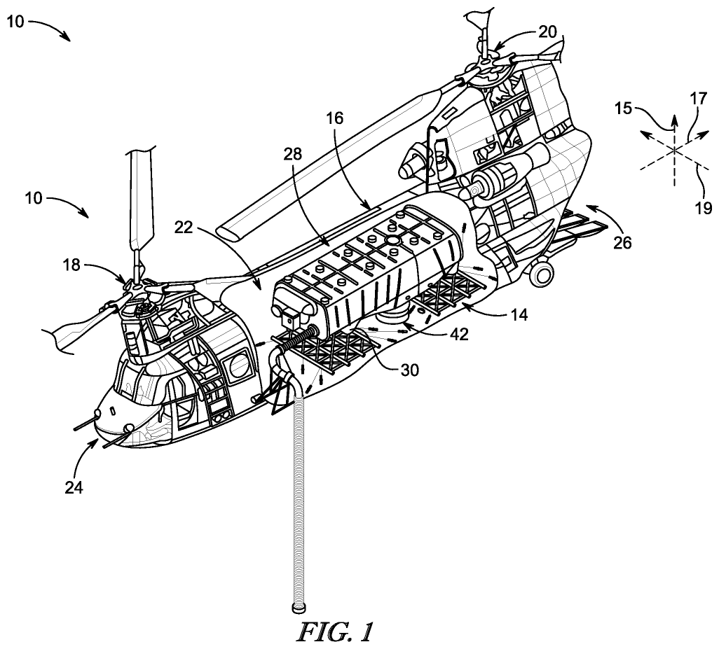

A fire-suppression system 10 in accordance with the present disclosure includes an aviation vehicle 12 (also called a helicopter 12) and a fluid transport and delivery system 14 as shown in FIG. 1. The fluid transport and delivery system 14 further includes a tank 30 and a plug 32 that cooperate to dispense a fire-suppression fluid or a fire-suppression foam from the helicopter 12 over a fire below the helicopter 12. The plug 32 is located above an exit nozzle 42 of the tank 30 and fluid or foam passes between the plug 32 and the exit nozzle 42 as it is dispensed through an exit aperture 56 formed in a bottom wall of the helicopter 12. The shape of the plug 32 cooperates with the exit nozzle 42 to cause the fluid to form a laminar flow as it is dispensed through the exit aperture 56 in the helicopter 12. The laminar flow minimizes interaction with a slipstream formed as a result of a propulsion system 18, 20 of the helicopter 12 to maximize the amount of fluid that reaches the fire and improve fire suppression of the fire-suppression system 10.

The helicopter 12 includes a vehicle frame 16, a first propeller unit 18, and a second propeller unit 20 as shown in FIG. 1. The vehicle frame 16 forms the main structural elements of the helicopter 12 to which other components and modules are attached. The first propeller unit 18 is coupled to a forward end 24 of the vehicle frame 16. The second propeller unit 20 is coupled to an aft end 26 of the frame 16 so that is it spaced apart from the first propeller unit 18 along a longitudinal axis 17 of the helicopter 12. Both the first propeller unit 18 and the second propeller unit 20 are positioned on an upper portion 28 of the vehicle frame 16 and include a motor and a plurality of propeller blades driven in rotation by the motor to provide lift for the helicopter 12. The vehicle frame 16 is formed to include a cabin 22 for the helicopter 12 where passengers and/or flight equipment may reside during flight including all or a portion of fluid transport and delivery system 14. In some embodiments, the helicopter 12 may include only a single propeller unit. In other embodiments, the helicopter 12 may be an alternative aviation vehicle such as an aircraft.

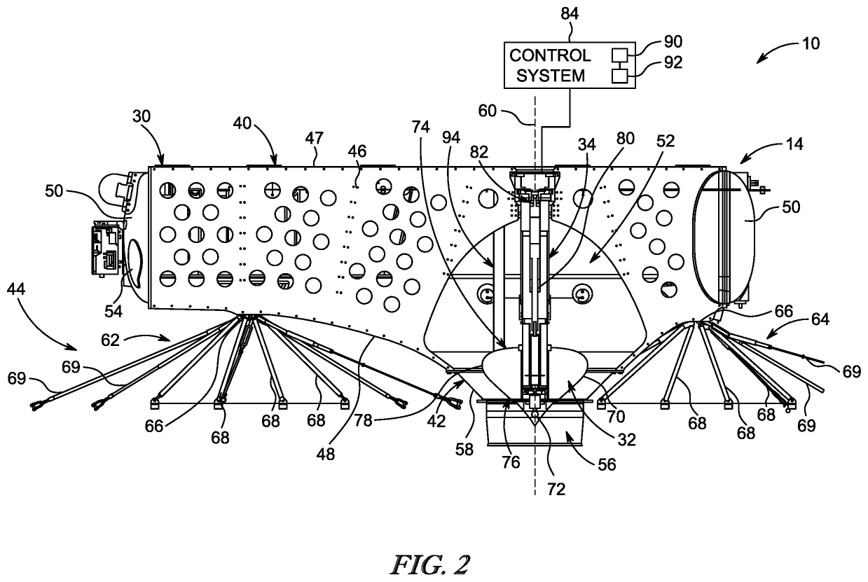

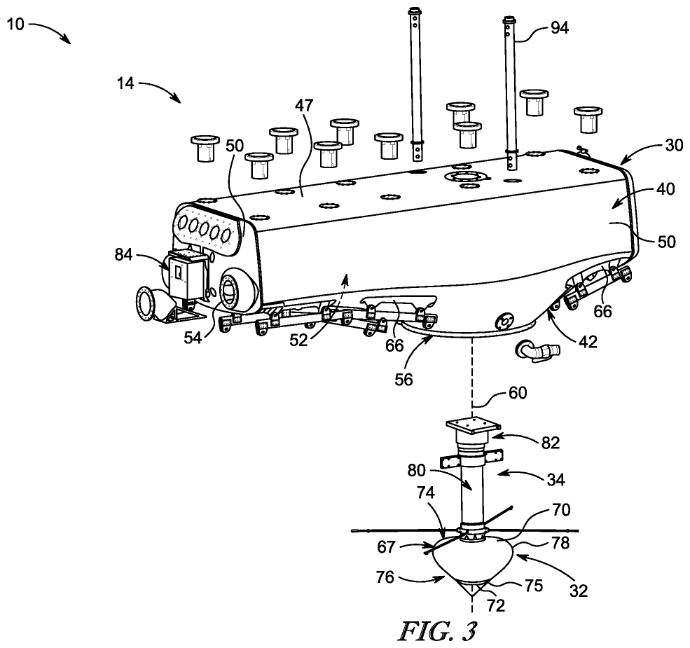

The fluid transport and delivery system 14 includes a tank 30, a plug 32, and a plug actuator 34 as shown in FIGS. 2 and 3. The fluid transport and delivery system 14 is coupled to the vehicle frame 16 and is located inside the cabin 22. The tank 30 fills a substantial portion of the cabin 22 and has a length that extends along the longitudinal axis 17 and that is longer than its width along a lateral axis 19 or its height along a vertical axis 15. The tank 30 is positioned aft of the first propeller unit 18 and forward of the second propeller unit 20. The tank 30 is further positioned toward the upper portion 28 of the vehicle frame 16 to maximize a head value of fluid stored in the tank 30 by locating a center of gravity of the helicopter 12 toward closer to the propeller units 18, 20 than other helicopters with fire suppression capabilities. The plug 32 and the plug actuator 34 are mounted inside the tank 30 to control discharge of fluid from the tank 30 during fire suppression activities. The increased head provided by the location of the tank 30 in the cabin 22 of the helicopter 12 allows for the plug 32 to establish a laminar flow of fluid that passes around the plug 32 and that exits the tank 30 to extinguish fires below.

Typical tanks coupled to aviation vehicles are positioned such that a center of gravity of the tank is as low on the vehicle as possible to provide a relatively low center of gravity relative to its propulsion system to increase stability of the vehicle. Tanks with a low center of gravity typically result in a relatively low fluid head value within the tank. The plug 32 in the illustrative embodiment is designed to be used with tank 30 to provide a relatively higher fluid head valve as a result of the shape and structure of the tank 30 and a location of the tank in the cabin 22 relative to the rest of the helicopter 12. The relatively higher fluid head value allows the plug 32 to form a laminar flow of fluid as the fluid passes around the plug 32 and exits the tank 30. The laminar flow produced by the shape of the plug 32 relative to the tank 30 maintains cohesion of the fluid as it falls toward the fire below the helicopter to minimize adverse effects from the slipstream caused by the propeller units 18, 20. In this way, the combination of tank 30 being positioned high in the cabin 22 and use of the plug 32 increases fire suppression abilities of the system 10.

The tank 30 includes a shell 40, an exit nozzle 42, a shell support unit 44, and a plurality of baffles 46 as shown in FIG. 2. The shell 40 is made from composite materials, such as carbon fiber, for example. The exit nozzle 42 is formed into the bottom of the tank 30. The exit nozzle 42 is centered along the lateral axis 19 of the tank 30 and is arranged aft of a midpoint of the tank 30 relative to the longitudinal axis 17. In some embodiments, the exit nozzle 42 may be positioned forward of the midpoint or aligned with the midpoint depending on the aviation vehicle the system 14 is installed in. The shell 40 may be formed to include one or more openings that are closed by hatches coupled to a side wall of the shell 40 to allow ingress and egress into an internal fluid-storage region 52 of the tank 30 or maintenance of components in the internal fluid-storage region 52 such as plug 32.

The shell support unit 44 couples the tank 30 to the vehicle frame 16 in a plurality of positions so that the tank 30 cannot move relative to the vehicle frame 16 during operation of the helicopter 12 as shown in FIGS. 1 and 2. The shell support unit 44 is configured to position the tank 30 in a raised position within the cabin 22 to achieve the head that provides the laminar flow of fluid from the exit aperture 56. The plurality of baffles 46 are located inside the tank 30 and are coupled to inside surfaces of the shell 40 of the tank 30. The baffles 46 are formed to include a plurality of openings and control movement of the fluid inside the tank 30 to prevent bulk movements of the fluid inside the tank 30 that could substantially shift the center of gravity of the helicopter 12. Some of the baffles 46 extend along the lateral axis 19 within the tank 30 while some of the baffles 46 extend along the longitudinal axis 17 within the tank 30. This arrangement prevents bulk movements of fluids forward and backward and side to side during pitch, yaw and tilt maneuvers of the helicopter 12.

The shell 40 includes a top wall 47, a floor 48, and a plurality of side walls 50 that extend between the top wall 47 and the floor 48 as shown in FIGS. 2 and 3. The shell 40 is shaped to substantially fill a portion of the cabin 22. Exterior surfaces of the shell may follow the contours of cabin walls defining cabin 22. In some embodiments, the shell may have vertical wall that does not match the contours of the cabin 22 to improve manufacturability of the shell 40. The shell 40 provides an internal fluid-storage region 52 for water, foam or other suitable fire-suppressing fluids. The shape of the shell 40 maximizes the volume of the internal fluid-storage region 52 so that there is more fluid available for fire suppression during a flight mission.

The floor 48 is located on the lower portion of the shell 40 and is coupled to the shell support unit 44 as shown in FIGS. 2 and 3. The floor 48 is formed to include the exit nozzle 42. The plurality of side walls 50 for extend around a perimeter of the shell 40. The plurality of side walls 50 connect the top wall 47 with the floor 48. The plurality of side walls 50 includes an inlet aperture 54 that is used as an inlet to fill the tank 30 with fluid. The inlet aperture 54 maybe formed on one of a forward facing wall, an aft facing wall, or a laterally facing wall of the plurality of side walls 50. The inlet aperture 54 may be connected to an inlet feed pipe and an inlet pump. To refill the tank 30 the inlet feed pipe extends below of the helicopter 12 into a fluid source and the inlet pump draws fluid into the fluid-storage region 52. The inlet pump may be coupled to a distal end of the inlet feed pipe to draw fluid from the fluid source and force the fluid into the tank 30.

The exit nozzle 42 is coupled to the floor 48 of the tank 30 as shown in FIGS. 2 and 3. The exit nozzle 42 is formed in the shape of a funnel and has an exit aperture 56 through which fluid can exit the tank 30. The exit nozzle 42 extends circumferentially around a vertical axis 60. The exit nozzle 42 has an inner surface 58 that has an increasing slope as the inner surface 58 extends downwardly relative to the vertical axis 60. The slope of the inner surface 58 extends circumferentially around the vertical axis 60 so that the cross-section of the exit nozzle 42 is substantially circular at different vertical heights along the vertical axis 60. The exit aperture 56 is located at the lowest point of the exit nozzle 42 and extends circumferentially around the vertical axis 60 and has circular shape.

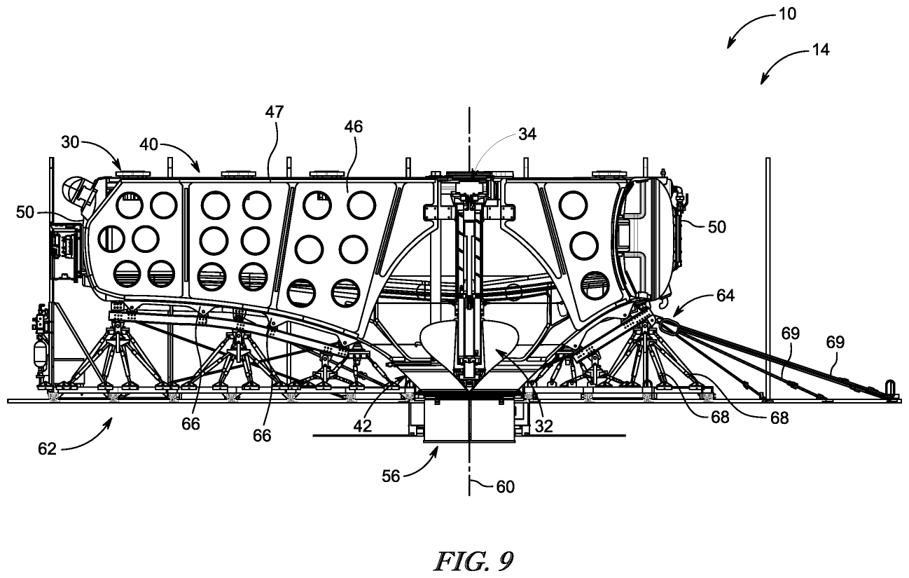

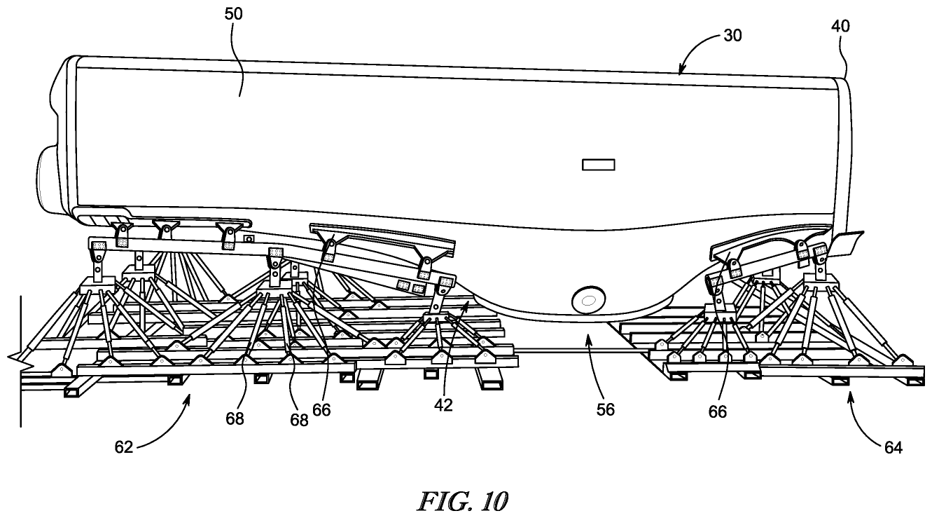

In some embodiments, the shell support unit 44 includes a forward support unit 62 and an aft support unit 64 as shown in FIGS. 1 and 2. In some embodiments, the shell support unit 44 includes multiple forward and aft supports 62, 64 as shown in FIG. 9. The forward support unit 62 is located forward of the exit nozzle 42 along the longitudinal axis 17. The aft support unit 64 is located aft of the exit nozzle 42 along the longitudinal axis 17. Both the forward and aft support unit 62, 64 couple with the floor 48 of the shell 40 and the vehicle frame 16 of the helicopter 12. Each support unit 62, 64 includes a plurality of struts 68 and a plurality of stringers 69 that each couple with a mounting flange 66 on the shell 40. In one example, each mounting flange 66 is coupled with approximately 8 struts 68. There may be multiple mounting flanges 66 spaced apart along the lateral axis 19 for each of the forward support unit 62 and aft support unit 64. The plurality of struts 68 extend away from each other relative to the lateral and longitudinal axes 17, 19 as the plurality of struts 68 extend downwardly from the mounting flange 66. The plurality of struts 68 couple with the vehicle frame 16 to form a grid. This allows the loads from the shell 40 to be transferred to the frame 16 and spread out over a large area to reduce stresses on the vehicle frame 16. The plurality of stringers 69 interconnect the mounting flange 66 and the vehicle frame 16 and apply tension between the mounting location and the vehicle frame 16 to increase support of the shell 40 on the vehicle frame 16.

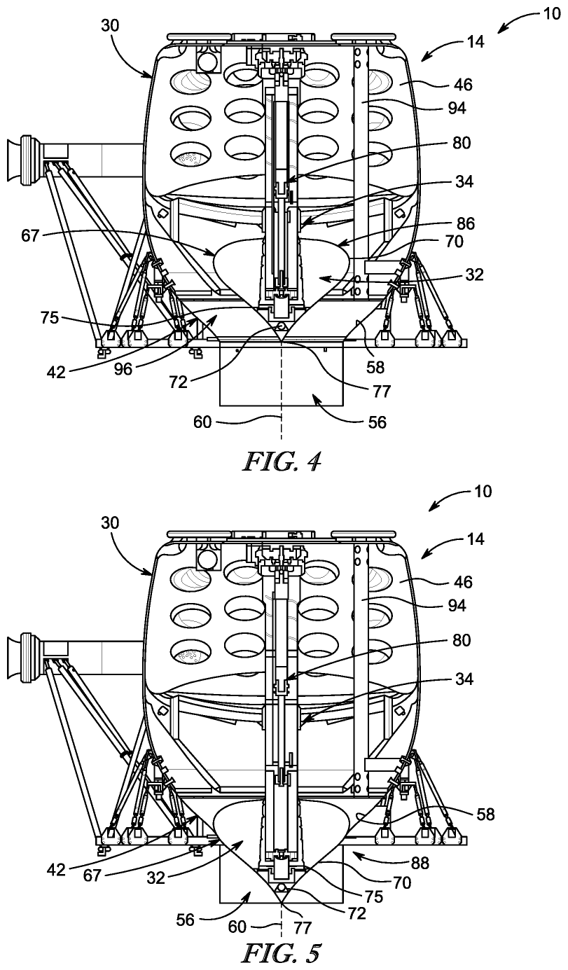

The plug 32 extends along the vertical axis 60 and is positioned in the exit nozzle 42 directly above the exit aperture 56 as shown in FIGS. 4 and 5. The plug 32 has an inverted teardrop shape when viewed from the side along the longitudinal and lateral axes 17, 19 and a circular cross-section when viewed from above along the vertical axis 60. The plug 32 has a maximum lateral plug diameter 78 relative to axes 17, 19 that is larger than the exit aperture 56 of the tank 30.

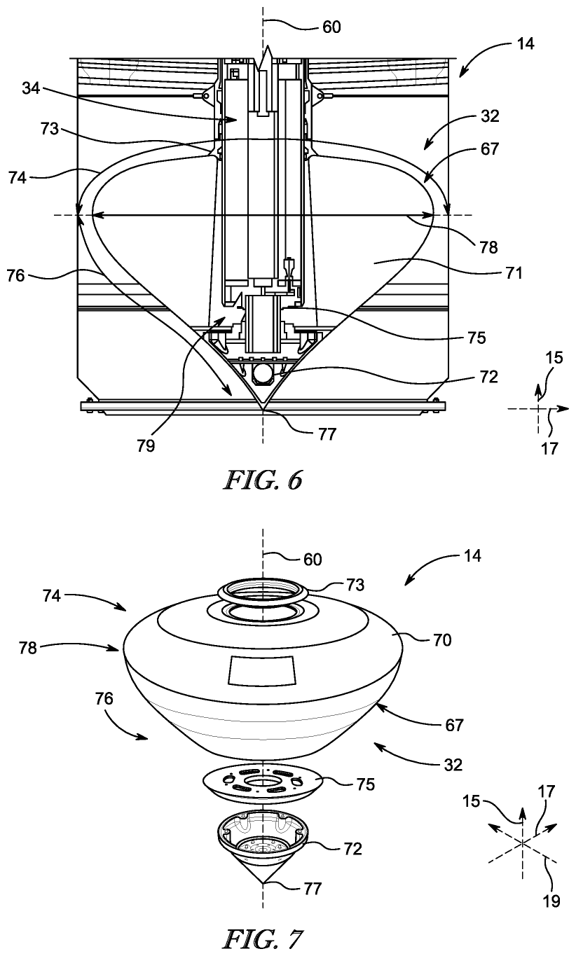

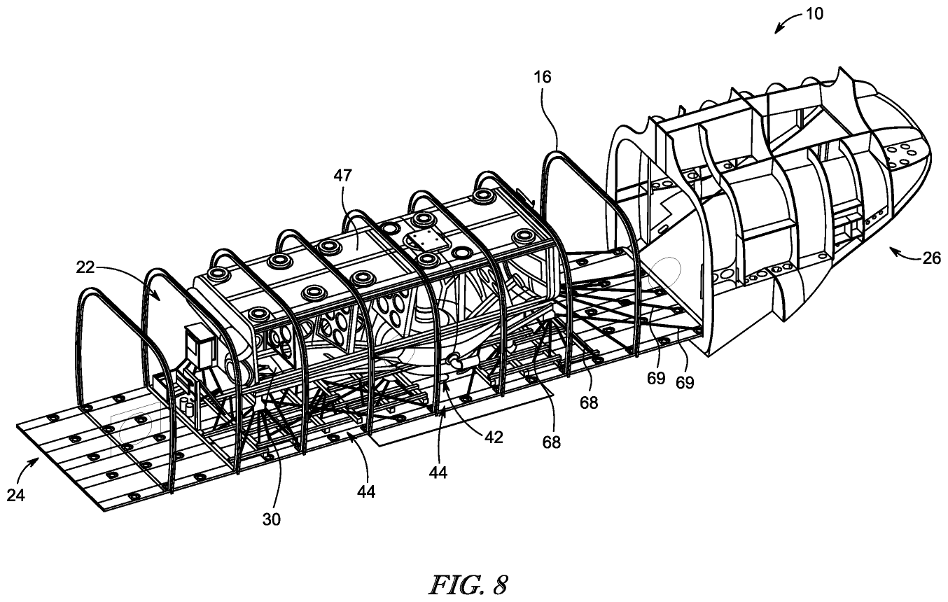

The plug 32 includes plug body 67, a point or terminal end 72, an upper plate 73, and a plug support plate 75 as shown in FIGS. 6 and 7. The plug body 67 is coupled to the plug support plate 75 to locate the plug body 67 within the tank 30. The point end 72 is coupled to the plug support plate 75 and located below the plug body 67. The point end 72 has a conical shape and cooperates with the plug body 67 to provide an outer surface of the plug 32 having the inverted teardrop shape as shown in FIGS. 6 and 7. The upper plate 73 engages with the plug actuator 34 to minimize lateral movement of the plug body 67 relative to the vertical axis 60 and to provide a seal to block fluid from entering a passageway 79 formed in the plug body 67. The plug support plate 75 is coupled to the plug actuator 34 to support the plug 32 within the tank 30.

The plug body 67 includes an outer layer 70 and a core 71 as shown in FIGS. 6 and 7. The core 71 is made from plastic and/or foam materials. The outer layer 70 may be made of composite material, such as carbon fiber, to provide additional strength for the plug body 67. The core 71 is formed to include passageway 79 through the center of the core 71 along the vertical axis 60. The upper plate 73 is bonded to the top of the core 71 and is formed to include an aperture that aligns with the passageway in the core 71. A seal may be provided between the upper plate 73 and the plug actuator 34 to block fluid from entering the passageway of the core 71.

The outer layer 70 defines a contour of the plug 32 that provides laminar fluid flow as the fluid exits the tank 30 through the exit aperture 56. The plug 32 has an upper portion 74 and lower portion 76. The upper portion 74 extends vertically upward from a maximum lateral plug diameter 78 of the plug 32 as shown in FIGS. 6 and 7. The upper portion 74 has a convex shape and extends away from the vertical axis 60 at the top of the plug 32. The upper portion 74 has a decreasing slope relative the vertical axis 60 as the outer layer 70 approaches the maximum lateral plug diameter 78 of the plug 32. At the maximum lateral plug diameter 78, the upper portion 74 transitions into the lower portion 76, and the lower portion 76 extends downward toward a terminal point 77 of the point end 72. The outer layer 70 in the lower portion 76 initially has a convex shape and converges toward the vertical axis 60 as it extends downward from the maximum lateral plug diameter 78 toward the point end 72. The lower portion 76 may transition from the convex shape to a concave shape between the terminal point 77 and the maximum lateral plug diameter 78. The outer layer 70 may be coupled to the point end 72 about midway between the maximum lateral plug diameter 78 and the terminal point 77. The point end 72 has a convex shape and converges toward the vertical axis 60 as it extends from the plug body 67 to the terminal point 77.

The plug actuator 34 includes a shaft 80, a motor 82, and a control system 84 as shown in FIG. 2. The plug actuator 34 is located inside the tank 30 and is aligned with the vertical axis 60. An upper end of the shaft 80 is coupled to the top wall of the shell 40 while a lower end of the shaft 80 moves relative to the shell 40 along the axis 60 to move the plug 32 between the open position and the closed position. The lower end of the shaft 80 extends through the passageway 79 in the core 71 and is coupled to the plug support plate 75 of the plug 32. The motor 82 is coupled with the shaft 80 so that when the motor 82 is activated it moves the lower end of the shaft 80 and the plug 32 to open and close the exit aperture 56 in the exit nozzle 42. The control system 84 controls the motor 82 to set the height of the plug 32 relative to the exit aperture 56 of the tank 30 from a fully open position 86 to a closed position 88. The plug 32 may be moved by the plug actuator 34 to any position between the fully opened position 86 and the closed position 88.

The control system 84 includes a processor 90, a memory storage device 92, and a fluid measuring device 94 and shown in FIG. 3. A user may initiate discharge of fluid from the tank 30 by applying one or more inputs that cause a signal to be sent to the processor 90. The memory storage device 92 stores instructions that, when executed, cause the processor 90 to output a command signal to the motor 82. The command signal instructs the motor 82 to translate the plug 32 along the vertical axis 60. Translation of the plug 32 along the vertical axis 60 may be controlled by various sensed conditions of the fire suppression system, such as, vehicle speed, altitude, temperature, fluid levels in the tank 30, or fire size, for example. In one example, system 14 includes a fluid measuring device 94 that determines a height of the fluid in the tank 30. The fluid measuring device 94 sends signals to the processor 90 indicative of the height of the fluid in the tank 30. The processor 90 may output a command signal to adjust the height of the plug 32 relative to the tank 30 to optimize the flow of the dispensing fluid depending on one or more sensed conditions, such as the height of the fluid in the tank 30.

In the closed position 88, the plug 32 is arranged in the exit aperture 56 so that the outer layer 70 of the plug 32 engages with the inner surface 58 of the exit nozzle 42 as shown in FIG. 5. Engagement between the plug 32 and the inner surface 58 forms a seal and blocks fluid from exiting the tank 30 through exit nozzle 42. As the plug actuator 34 translates the plug 32 toward the open position 86, the outer layer 70 of the plug 32 moves away from the inner surface 58 of the exit nozzle 42 to open the exit aperture 56. Fluid may then exit the tank between the plug 32 and the inner surface 58 of the exit nozzle 42.

The contours of the plug 32 and the inner surface 58 cooperate to form a divergent passageway 96 at a height corresponding to the point end 72 that encourages laminar flow of the fluid exiting the tank 30. The open position 86 may be a plurality of positions of the plug 32 relative to the exit nozzle 42 providing fluid can exit the tank as shown in FIG. 4. The control system 84 can control the height of the plug 32 relative to the exit nozzle 42 to control the shape and area of the divergent passageway 96 by changing a height of the point end 72 relative to exit nozzle 42 to optimize the laminar flow of the exiting fluid depending on the height of the helicopter 12, the height of the fluid in the tank 30, the volume of fluid desired to be dispensed, or any other sensed condition.

In some embodiments, a spade door system 32 may create a laminar flow of the liquid discharged. In laminar flow, sometimes called streamline flow, the velocity, pressure, and other flow properties at each point in the fluid may remain constant. Laminar flow over a horizontal surface may be thought of as consisting of thin layers, or laminae, all parallel to each other. The fluid in contact with the horizontal surface is stationary, but all the other layers slide over each other.

In some embodiments, the present disclosure may be an improvement over typical gated or actuated door drops where the liquid may be disturbed during the drop and may be allowed to breakup when the column of water enters the aircraft slip stream and dissipates in the vacuum behind the aircraft. The present disclosure may keep the water column tight and uniform though out the drop sequence without the dissipation sometimes typical with helicopters and fixed wing aircraft.

In some embodiments, the tank 30 may be manufactured out of ultra-light and ultra-strong carbon fiber material. The support structure may include a tie down support system that may benefit the aircraft and occupant safety in the event of a crash or mishap. The invention may allow for quick change to bucket installation while the tank 30 remains in the aircraft 12. For extended bucket operations tank may be removed during night shift maintenance activities.

While the disclosure has been illustrated and described in detail in the foregoing drawings and description, the same is to be considered as exemplary and not restrictive in character, it being understood that only illustrative embodiments thereof have been shown and described and that all changes and modifications that come within the spirit of the disclosure are desired to be protected.

What is claimed is:

1. A fire-suppression system comprising
an aviation vehicle including a vehicle frame formed to include a cabin, a first propeller unit mounted to a forward end of the vehicle frame, and a second propeller unit mounted to an aft end of the vehicle frame, and
a fluid transport and delivery system coupled to the vehicle frame and located within the cabin,
wherein the fluid transport and delivery system includes a tank having an exit aperture formed in a bottom wall of the tank, a plug aligned with the exit aperture of the tank, and a plug actuator configured to move the plug along an axis from an open position, in which the fluid stored in the tank passes around the plug and through the exit aperture, to a closed position, in which the plug extends through the aperture and engages the bottom wall of the tank to block fluid from passing through the exit aperture.

2. The fire-suppression system of claim 1, wherein the tank includes a shell, an exit nozzle coupled to the bottom wall, the exit nozzle formed to include the exit aperture that is arranged along the vertical axis, and a shell support unit configured to position the shell in a location within the cabin that maximizes a head value of fluid within the shell so that the plug provides a laminar flow of the fluid as the fluid passes around the plug and through the exit aperture.

3. The fire-suppression system of claim 2, wherein the plug actuator is configured to vary a position of the plug along the vertical axis to correspond to an elevation of the aviation vehicle in flight to optimize the laminar flow of the fluid.

4. The fire-suppression system of claim 3, wherein the plug actuator can vary the position of the plug along the aperture axis to correspond to a height of fluid in the tank and corresponding fluid head pressure.

5. The fire-suppression system of claim 1, wherein the plug and the exit nozzle cooperate to form a divergent passageway for fluid to pass between the plug and the exit nozzle when the plug is in the open position.

6. The fire-suppression system of claim 1, wherein the fluid transport and delivery system further includes an inlet feed pipe coupled to the inlet aperture and an inlet pump coupled to a distal end of the inlet feed pipe such that the inlet pump is spaced apart from the aviation vehicle during a refiling operation of the fluid transport and delivery system.

7. A fire-suppression system for an aviation vehicle, the fire-suppression system comprising
a tank including a shell comprising composite materials and being formed to include an internal fluid-storage region and an inlet aperture located on a side wall of the shell that opens into the internal fluid-storage region, a plurality of baffles located in the internal fluid-storage region and arranged to extend along a length and a width of the tank, an exit nozzle coupled to a bottom surface of the shell, the exit nozzle formed to include an exit aperture that is arranged along a vertical axis, and a shell support unit including a forward support structure located forward of the vertical axis and an aft support structure located aft of the vertical axis,
a plug aligned with the exit aperture on the vertical axis, and
a plug actuator coupled to the shell and the plug, plug actuator configured to move the plug along the vertical axis from an open position, in which the fluid passes around the plug and through the exit aperture and forms a laminar flow as it exits through the nozzle, to a closed position, in which the plug engages the exit nozzle to block fluid from passing through the exit aperture.

8. The fire-suppression system of claim 7, wherein the plug and the exit nozzle cooperate to form a divergent passageway for fluid to pass between the plug and the exit nozzle when the plug is in the open position.

9. The fire-suppression system of claim 8, wherein the plug is arranged to lie within the interior fluid-storage region in the open position and the plug is at least partially arranged within the interior fluid-storage region in the closed position.

10. The fire-suppression system of claim 9, wherein the upper portion transitions to the lower portion at a maximum diameter of the plug, and wherein the lower portion extends from the maximum diameter of the plug to a terminal end that is arranged along the axis.

11. The fire-suppression system of claim 10, wherein the lower portion has a convex shape from the maximum diameter of the plug to a point between the maximum diameter and the terminal end and the lower portion has a concave shape from the point to the terminal end.

12. The fire-suppression system of claim 7, wherein the vertical axis is offset toward an aft end of the tank.

13. The fire-suppression system of claim 7, wherein the forward support unit and the aft support unit each include a plurality of struts and a plurality of stringers.

14. The fire-suppression system of claim 7, wherein the plug actuator includes a shaft, a motor, and a control system, and a lower end of the shaft extends through a passageway formed in the plug.

15. A fire-suppression system comprising
a tank formed to include an interior fluid-storage region and an exit aperture formed in a bottom wall of the tank and
a plug coupled to the tank and configured to move between a first position, in which the exit aperture is open, and a second position, in which the plug is arranged to lie in the exit aperture to close the exit aperture,
wherein the plug is symmetrical relative to an axis that extends through a center of the exit aperture and the plug includes a dome-shaped upper portion and a conical-shaped lower portion such that the plug has an inverted teardrop cross-section when viewed from the side.

16. The fire-suppression system of claim 15, wherein the plug is arranged to lie within the interior fluid-storage region in the open position and the plug is at least partially arranged within the interior fluid-storage region in the closed position.

17. The fire-suppression system of claim 16, wherein the upper portion and the lower portion each include a portion of a plug core and a portion of a plug cover of the plug.

18. The fire-suppression system of claim 16, wherein the upper portion transitions to the lower portion at a maximum diameter of the plug, and wherein the lower portion extends from the maximum diameter of the plug to a terminal end that is arranged along the axis.

19. The fire-suppression system of claim 18, wherein the lower portion has a convex shape from the maximum diameter of the plug to a point between the maximum diameter and the terminal end and the lower portion has a concave shape from the point to the terminal end.

20. The fire-suppression system of claim 16, wherein the plug core comprises at least one of a plastic and a foam material, and wherein the plug cover comprises a composite material.
